(19) United States
(12) Patent Application Publication
(10) Pub. No.: US 2008/0222323 A1
(43) Pub. Date: Sep. 11, 2008

(54) MULTIMEDIA ADAPTING APPARATUS

(75) Inventor: Hsiang-Chi Hsieh, Sindian City (TW)

Correspondence Address: MADSON & AUSTIN, 15 WEST SOUTH TEMPLE, SUITE 900, SALT LAKE CITY, UT, 84101, US

(73) Assignee: Genesys Logic, Inc., Shindian City (TW)

(21) Appl. No.: 12/105,891

(22) Filed: Apr. 18, 2008

Related U.S. Application Data
(63) Continuation of application No. 11/452,194, filed on Jun. 14, 2006.

(51) Int. Cl. G06F 3/00

(52) U.S. Cl. 710/52

(57) ABSTRACT

The present invention discloses a multimedia adapting apparatus. The multimedia adapting apparatus includes a communicating module, a buffer, a primary controller, a command register, a status register, a secondary controller, a media hardware engine, and a memory unit. The buffer stores the audiovisual content from the multimedia player. The primary controller handles the operation of audiovisual content between the multimedia player and the portable multimedia devices. The status register stores a plurality of statuses associated with the portable multimedia devices. The command register stores a command set associated the operation of audiovisual content between the multimedia player and the portable multimedia devices according to the statuses of the status register. The communicating module couples the buffer and the primary controller, respectively, to the multimedia player, for communicating with the multimedia player based on a plurality of control signals associated with the command set.

### CROSS REFERENCE TO RELATED APPLICATION

This patent application is a Continuation-in-Part and claims priority of U.S. application Ser. No. 11/452,194, entitled “MULTIMEDIA DEVICE FOR CARS”, which is filed on Jun. 14, 2006, incorporated herein by reference.

### FIELD OF THE INVENTION

The present invention relates to an adapting apparatus, and more particularly, relates to a multimedia adapting apparatus applicable to multimedia players used in transportation vehicles, such as cars and airplanes.

### BACKGROUND OF THE INVENTION

Most of transportation vehicles, such as cars and airplanes, are popularly utilized in many places. As the rapid research and development of the transportation vehicles, an audiovisual device is installed in the transportation vehicle to be indispensable.

Conventional multimedia players for transportation vehicles, such as Digital Versatile Disk (DVD) and Video Compact Disk (VCD) players, are only for playing pre-recorded media storages, such as DVD disk and VCD disk. Conventional multimedia players for transportation vehicles cannot be used with various multimedia devices, such as MP3 player, flash memory sticks, notebook computers, mobile phones, personal digital assist (PDA), digital camera, recording pen, and so on. Therefore, the functions provided by multimedia players for transportation vehicles are limited. Since the multimedia devices for households and offices are rapidly developed and widely used, it is important to integrate the multimedia devices into the multimedia players for transportation vehicles.

### SUMMARY OF THE INVENTION

One objective of the present invention is to provide a multimedia adapting apparatus for allowing a multimedia player to control the audiovisual content of portable multimedia device as if the portable multimedia device is directly connected to the multimedia player.

Another objective of the present invention is to provide a multimedia adapting apparatus for allowing the portable multimedia device to download and store the audiovisual source of the multimedia player via the multimedia adapting apparatus effectively.

In one embodiment, A multimedia device, comprises: a player data bus, connected to a data bus to a multimedia player for transmitting audiovisual content; a player I/O interface, connected to an I/O interface of the multimedia player; a microprocessor connected to the player data bus and the player I/O interface, for forming bi-directional data transmission connection with the multimedia player through the player data bus and the player I/O interface, wherein the microprocessor controls the play data bus and the player I/O interface to communicate with the multimedia player based on a plurality of control signals; a memory unit, connected to the microprocessor to provide temporary storage of data and programs to the microprocessor; a USB controller, connected to the microprocessor, and connected externally to a digital multimedia device having an USB interface, for bi-directional data transmission between the external digital multimedia device and the multimedia player; a buffer, connected to the microprocessor and the USB controller to provide temporary storage; and a media hardware engine, connected to the buffer and the microprocessor, and connected externally to a flash memory card for providing bi-directional data transmission between the external flash memory card and the multimedia player.

In another embodiment, the present invention sets forth a multimedia adapting apparatus. The multimedia adapting apparatus includes a communicating module, a buffer, a primary controller, a command register, a status register, a secondary controller, a media hardware engine (MHE), and a memory unit. The multimedia adapting apparatus controls an operation of audiovisual content between a multimedia player and a plurality of portable multimedia devices.

The buffer stores the audiovisual content from the multimedia player. The primary controller handles the operation of audiovisual content between the multimedia player and the portable multimedia devices. The status register stores a plurality of statuses associated with the portable multimedia devices. The command register stores a command set associated the operation of audiovisual content between the multimedia player and the portable multimedia devices according to the statuses of the status register. The communicating module couples the buffer and the primary controller, respectively, to the multimedia player, for communicating with the multimedia player based on a plurality of control signals associated with the command set.

In one embodiment, the primary controller has the function of management system of the file format for managing the audiovisual and/or data. The secondary controller further has the function of the OTG dual role. Therefore, besides the multimedia player can read or write the audiovisual content between the multimedia player and portable multimedia device via the multimedia adapting apparatus, the audiovisual content and/or data can be copied, backup or modified between the portable multimedia devices via the secondary controller and the media hardware engine (MHE) of the multimedia adapting apparatus.

More importantly, the configurable unit configures the interface module according the control signals of the multimedia adapting apparatus. The control signals include a chip select signal (SCS), an address signal (SA), a read enabled signal (SRE), a write enabled signal (SWE), data signal (SD), a write status signal (SWS), and a read status signal (SRS). For example, the interface module is compatible with the advanced technology attachment (ATA) interface or SRAM interface so that the processing device of the multimedia player controls the configurable unit to configure the interface module and meet the control signals which are controlled by the communicating module of the multimedia adapting apparatus.

In the present invention, the control signals of the multimedia adapting apparatus include a chip select signal (SCS), an address signal (SA), a read enabled signal (SRE), a write enabled signal (SWE), data signal (SD), a write status signal (SWS), and a read status signal (SRS).

The chip select signal (SCS) represents the multimedia adapting apparatus is active while the multimedia adapting apparatus is selected by multimedia player. For example, the multimedia adapting apparatus is active while the chip select signal (SCS) is at low level. The address signal (SA) determines whether the multimedia adapting apparatus is operated at command write mode and status read mode, or at a data receiving/transmitting mode. For example, while the address signal (SA) is high level, the multimedia adapting apparatus is operated at the command write mode and status read mode. Conversely, while the address signal (SA) is low level, the multimedia adapting apparatus is operated at the data receiving/transmitting mode.

The read enabled signal (SRE) represents that the multimedia adapting apparatus can be read by the multimedia player while the read enabled signal (SRE) is active, e.g. at a low level. The write enabled signal (SWE) represents that the multimedia adapting apparatus can be written by the multimedia player while the write enabled signal (SWE) is active, e.g. at a low level. The data signal (SD) represents that the data, status, command and address are transmitted between the multimedia player and the multimedia adapting apparatus.

The write status signal (SWS) indicates that the multimedia player is capable of writing command and/or data to the multimedia adapting apparatus while the write status signal (SWS) is active, e.g. at a high level. The read status signal (SRS) indicates that the multimedia player is capable of reading command and/or data from the multimedia adapting apparatus while the read status signal (SRS) is active, e.g. at a high level.

While the chip select signal (SCS) is activated at a low level, a processing device of the multimedia player continuously controls the write enable signal (SWE) and writes the data signal (SD) associated with the audiovisual content to the buffer via the communicating module. That is, the multimedia adapting apparatus controls the writing operation of the audiovisual content from the multimedia player to the portable multimedia device via the buffer and the communicating module.

While the chip select signal (SCS) is activated at a low level, the processing device of the multimedia player continuously controls the read enable signal (SRE) and reads the data signal (SD) associated with the audiovisual content via the communicating module. That is, the multimedia adapting apparatus controls the reading operation of the audiovisual content from the portable multimedia device to the multimedia player via the buffer and the communicating module. Therefore, the multimedia adapting apparatus is capable of accessing the audiovisual content between the portable multimedia devices and the multimedia player. The accessing procedure includes the operations of playing, downloading and storing the audiovisual content.

### BRIEF DESCRIPTION OF THE DRAWINGS

The foregoing aspects and many of the attendant advantages of this invention will become more readily appreciated as the same becomes better understood by a reference to the following detailed description, when taken in conjunction with the accompanying drawings, wherein:

FIG. 1 is a schematic diagram depicting a multimedia device for controlling the operation of the audiovisual content between a multimedia player and portable multimedia devices according to a first embodiment of the present invention;

FIG. 2 is a schematic diagram depicting a multimedia device for controlling the operation of the audiovisual content between a multimedia player and portable multimedia devices according to a second embodiment of the present invention;

FIG. 3 is a schematic diagram depicting a multimedia device for controlling the operation of the audiovisual content between a multimedia player and portable multimedia devices according to a third embodiment of the present invention;

FIG. 4 is a schematic timing diagram depicting a command writing procedure of the communicating module according to one embodiment of the present invention;

FIG. 5 is a schematic timing diagram depicting a status reading procedure of the communicating module according to one embodiment of the present invention;

FIG. 6 is a schematic timing diagram depicting a data writing procedure of the communicating module according to one embodiment of the present invention; and

FIG. 7 is a schematic timing diagram depicting a data reading procedure of the communicating module according to one embodiment of the present invention.

### DETAILED DESCRIPTION OF THE INVENTION

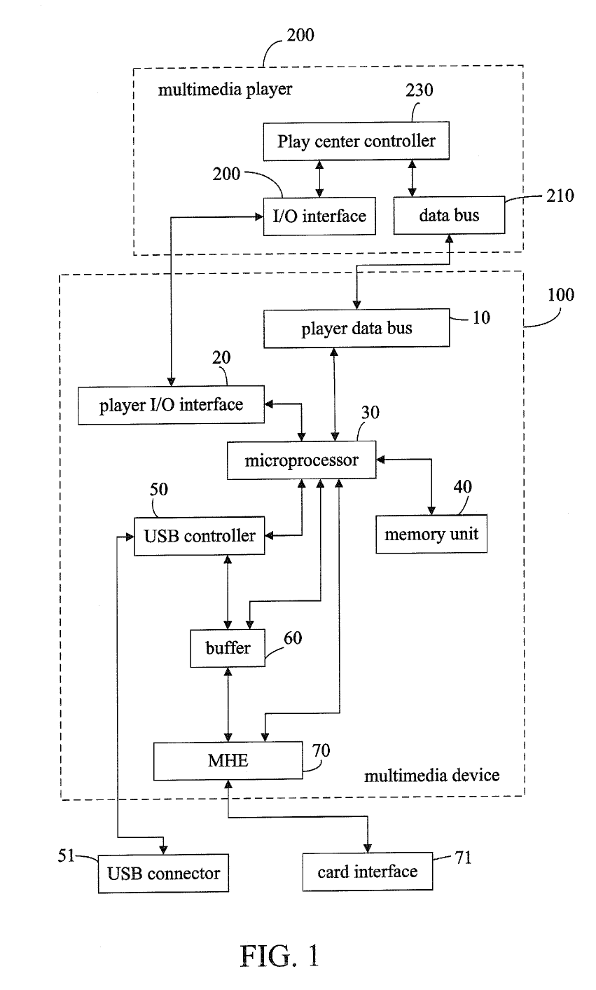

FIG. 1 is a schematic diagram depicting a multimedia device 100 for controlling the operation of the audiovisual content (or named data) between a multimedia player 200 and portable multimedia devices according to a first embodiment of the present invention. A multimedia device 100 includes a player data bus 10, a player input/output (I/O) interface 20, a microprocessor 30, a memory unit 40, a universal serial bus (USB) controller 50, a buffer 60, and a media hardware engine (MHE) 70. The player data bus 10 and the player I/O interface 20 are connected, respectively, to a data bus 210 and an I/O interface 220 of a multimedia player 200. The multimedia player 200 is not limited to any specific type, such as a DVD player and/or a VCD player.

The multimedia player 200 includes a play center controller 230 for controlling the playing of the DVD media. The data bus 210 and the I/O interface 220 are connected to the play center controller 230 so that the play center controller 230 controls data input/output. The player data bus 10 and the player I/O interface 20, through the connection to the data bus 210 and the I/O interface 20, are connected to the play center controller 230 for bi-directional data transmission.

The microprocessor 30 controls the transmission and storage of the media data. The microprocessor 30 is pre-installed with programs for controlling the format conversion, transmission, and storage of the media data. The microprocessor 30 is connected to the player data bus 10 and the player I/O interface 20. By using the player data bus 10 and the player I/O interface 20, the microprocessor 30 is capable of receiving the data from or transmitting data to the play center controller 230 of the multimedia player 200. The memory unit 40 is connected to the microprocessor 30 to provide the temporary storage for the data or program. The memory unit 40 is not limited to any specific type. This embodiment uses synchronous dynamic RAM (SDRAM) as an example. The microprocessor 30 controls the play data bus 10 and the player I/O interface 20 to communicate with the multimedia player 200 based on a plurality of control signals.

The USB controller 50, the buffer 60, and the MHE 70 serially form a USB interface. The USB controller 50, the buffer 60, and the MHE 70 are connected and controlled by microprocessor 30, respectively. The USB controller 50 is connected to a USB connector 51, which provides connections to a multimedia device 100 with a USB interface, such as MP3 player, flash memory stick, notebook computer, mobile phone, PDA, digital camera, recording pen, and so on. By using the USB controller 50, the multimedia device 100 with a USB interface can transmit the audiovisual content, through the microprocessor 30, the player data bus 10, the player I/O interface 20, to the play center controller 230 of the multimedia player 200 for processing and playing. Conversely, the audiovisual content in the play center controller 230 can be downloaded and stored in the multimedia device 100 with a USB interface.

The buffer 60 provides the temporary storage to buffer data when the amount of data is large. The buffer 60 is connected to the MHE 70, so that the MHE 70 becomes a card-reading interface. The MHE 70 is connected to a card interface 71, through which the connection to a flash memory card is provided. A flash memory card connected to the card interface 71 can transmit the audiovisual content to the play center controller 230 of the multimedia player 200 via the MHE 70, the microprocessor 30, the player data bus 10, and the player I/O interface 20, for processing and playing. Conversely, the audiovisual content in the play center controller 230 can be downloaded and stored in the flash memory card via the aforementioned path.

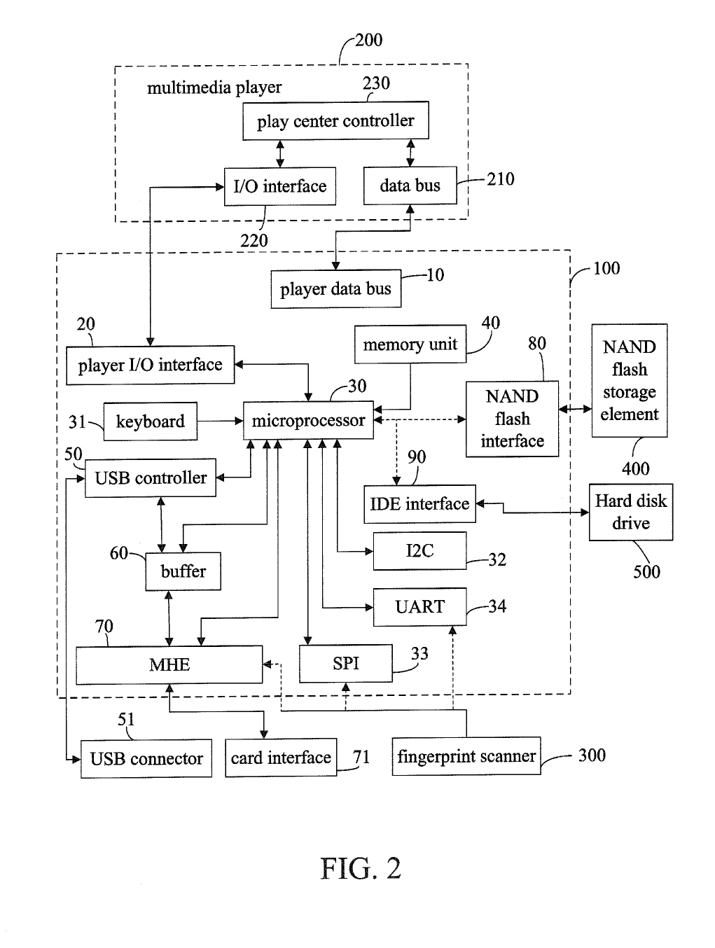

FIG. 2 is a schematic diagram depicting a multimedia adapting apparatus for controlling the operation of the audiovisual content between a multimedia player and portable multimedia devices according to a second embodiment of the present invention. The memory unit 40 stores the image data of the fingerprints of the user. This embodiment is applied to a multimedia player 200 with a different type of I/O interface. The multimedia player 200 includes an inter-integrated circuit (I2C) 250, a serial peripheral interface (SPI) 260, and an UART 270. The microprocessor 30 is connected to a keyboard 31, an I2C 32, a SPI 33, a universal asynchronous receiver (UART) 34, a Not AND (NAND) flash interface 80 and an integrated drive electronics (IDE) interface 90. The keyboard 31 provides the instruction input to the microprocessor 30, such as uploading for playing on the play module 230 of the multimedia player 200 or data transmission for storage between the flash memory card 400 and the multimedia device 300 with a USB interface. The keyboard 31 can be either stand alone or integrated into the controller 240 of the multimedia player 200 for airplane seats.

As shown in FIG. 2, the I2C 32, the SPI 33 and the UART 34 serially form a structure for transmission of different data type and interface. Therefore, the multimedia I/O interface device 100 of the present invention can be applied to the multimedia player 200 for airplane seats with different types of interface.

The NAND flash interface 80 and the IDE interface 90 provide connections to a NAND flash storage element 500 and a hard disk drive 600, respectively. By using the microprocessor 30 and the USB OTG controller 50, bi-directional data transmission between the flash memory card 400 connected to the card interface 71 and the multimedia devices 300 connected to the USB connector 51 can be executed. For example, the global positioning system (GPS) map can be uploaded to a flash memory stick with the USB interface. Similarly, by using the microprocessor 30, the buffer 60, the MHE 70, and the card interface 71, the bi-directional data transmission can also be performed between the NAND flash storage element 500, the hard disk drive 600 and the flash memory card 400 connected to card interface 71.

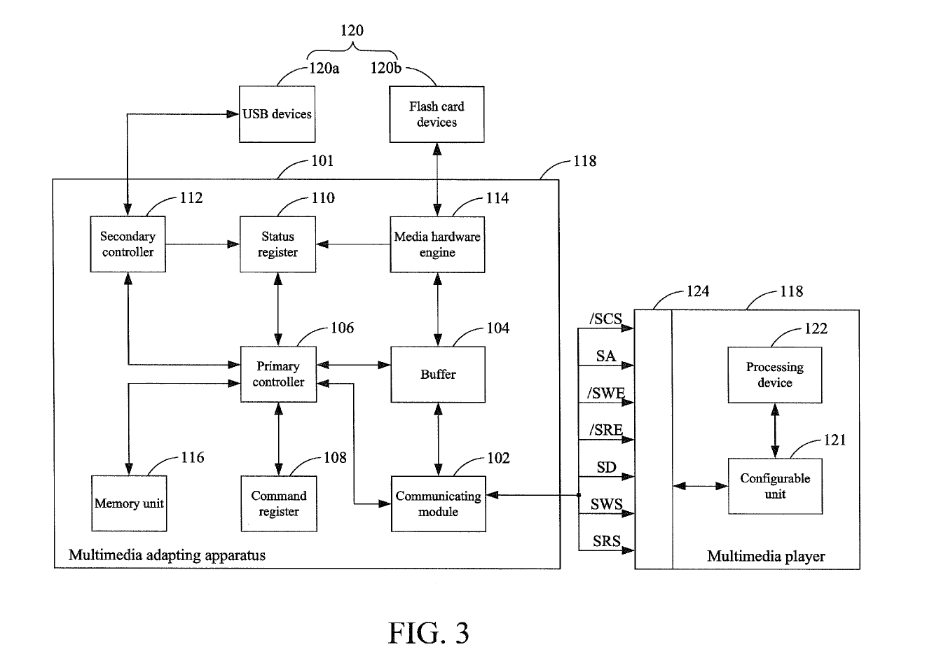

FIG. 3 is a schematic diagram depicting a multimedia adapting apparatus 101 for controlling the operation of the audiovisual content between a multimedia player 118 and portable multimedia device 120 according to a third embodiment of the present invention. The multimedia adapting apparatus 101 includes a communicating module 102, a buffer 104, a primary controller 106, a command register 108, a status register 110, a secondary controller 112, a media hardware engine (MHE) 114, and a memory unit 116. The multimedia adapting apparatus 101 controls the operation of audiovisual content between the multimedia player 118 and a plurality of portable multimedia devices. For example, the portable multimedia devices 120 includes USB devices 120a, such as card reader, digital camera, and personal digital assistant (PDA), and flash card devices 120b, such as SM card, XD card, SD card. Preferably, the secondary controller 112 is compatible with USB standard, such as USB on-the-go (OTG) standard. The portable multimedia device 120 includes a variety of flash memory cards. The multimedia adapting apparatus 101 applicable to multimedia players used in transportation vehicles, such as cars and airplanes.

The multimedia adapting apparatus 101 is coupled to the multimedia player 118 via the communicating module 102. The communicating module 102 is coupled to the processing device 122 of the multimedia player 118 via the interface module 124 and the configurable unit 121. The buffer 104 is coupled to the communicating module 102, the primary controller 106 and the media hardware engine (MHE) 114, respectively. The primary controller 106 is coupled to the communicating module 102, the buffer 104, the command register 108, the status register 110, the secondary controller 112, and the memory unit 116, respectively.

The buffer 104 stores the audiovisual content from the multimedia player 118. The primary controller 106 handles the operation of audiovisual content between the multimedia player 118 and the portable multimedia devices 120. In one embodiment, the primary controller 106 further monitors a plurality of status change events of the portable multimedia devices 120. The status register 110 stores a plurality of statuses associated with the portable multimedia devices 120. The status register 110 further records the status change events. For example, the status change events include the portable multimedia devices plug into or disconnect from the multimedia adapting apparatus 101. The command register 108 stores a command set associated the operation of audiovisual content between the multimedia player 118 and the portable multimedia devices 120 according to the statuses of the status register 110. The communicating module 102 couples the buffer 104 and the primary controller 106, respectively, to the multimedia player 118, for communicating with the multimedia player 118 based on a plurality of control signals associated with the command set.

In one embodiment, the primary controller 106 has the function of management system of the file format for managing the audiovisual and/or data. The secondary controller 112 further has the function of the OTG dual role. Therefore, besides the multimedia player 118 can read or write the audiovisual content between the multimedia player 118 and portable multimedia device 120 via the multimedia adapting apparatus 101, the audiovisual content and/or data can be copied, backup or modified between the portable multimedia devices 120, such as between USB devices and flash card devices, via the secondary controller 112 and the media hardware engine (MHE) 114 of the multimedia adapting apparatus 101.

More importantly, the configurable unit 121 configures the interface module 124 according the control signals of the multimedia adapting apparatus 101. The control signals include a chip select signal (SCS), an address signal (SA), a read enabled signal (SRE), a write enabled signal (SWE), data signal (SD), a write status signal (SWS), and a read status signal (SRS). For example, the interface module 124 is compatible with the advanced technology attachment (ATA) interface or SRAM interface so that the processing device 122 of the multimedia player 118 controls the configurable unit 121 to configure the interface module 124 and meet the control signals which are controlled by the communicating module 102 of the multimedia adapting apparatus 101. These control signals will be described in detail below.

The chip select signal (SCS) represents the multimedia adapting apparatus 101 is active while the multimedia adapting apparatus 101 is selected by multimedia player. For example, the multimedia adapting apparatus 101 is active while the chip select signal (SCS) is at low level. The address signal (SA) determines whether the multimedia adapting apparatus 101 is operated at command write mode and status read mode, or at a data receiving/transmitting mode. For example, while the address signal (SA) is high level, the multimedia adapting apparatus 101 is operated at the command write mode and status read mode. Conversely, while the address signal (SA) is low level, the multimedia adapting apparatus 101 is operated at the data receiving/transmitting mode. Due to the address signal (SA), the multimedia adapting apparatus 101 allows the portable multimedia device 120 to download and store the audiovisual source of the multimedia player 118 effectively.

The read enabled signal (SRE) represents that the multimedia adapting apparatus 101 can be read by the multimedia player 118 while the read enabled signal (SRE) is active, e.g. at a low level. The write enabled signal (SWE) represents that the multimedia adapting apparatus 101 can be written by the multimedia player 118 while the write enabled signal (SWE) is active, e.g. at a low level. The data signal (SD) represents that the audiovisual content, the statuses, and the command set are transmitted between the multimedia player 118 and the multimedia adapting apparatus 101.

The write status signal (SWS) indicates that the multimedia player 118 is capable of writing command and/or data to the multimedia adapting apparatus 101 while the write status signal (SWS) is active, e.g. at a high level. The read status signal (SRS) indicates that the multimedia player 118 is capable of reading command and/or data from the multimedia adapting apparatus 101 while the read status signal (SRS) is active, e.g. at a high level.

While the chip select signal (SCS) is activated at a low level, a processing device 122 of the multimedia player 118 continuously controls the write enable signal (SWE) and writes the data signal (SD) associated with the audiovisual content to the buffer 104 via the communicating module 102. That is, the multimedia adapting apparatus 101 controls the writing operation of the audiovisual content from the multimedia player 118 to the portable multimedia device 120 via the buffer 104 and the communicating module 102.

While the chip select signal (SCS) is activated at a low level, the processing device 122 of the multimedia player 118 continuously controls the read enable signal (SRE) and reads the data signal (SD) associated with the audiovisual content via the communicating module 102. That is, the multimedia adapting apparatus 101 controls the reading operation of the audiovisual content from the portable multimedia device 120 to the multimedia player 118 via the buffer 104 and the communicating module 102. Therefore, the multimedia adapting apparatus 101 is capable of accessing the audiovisual content between the portable multimedia devices 120 and the multimedia player 118. The accessing procedure includes the operations of playing, downloading and storing the audiovisual content.

In one embodiment, the command set is selected from one group consisting of a reading command, a writing command, formatting command and the combinations thereof.

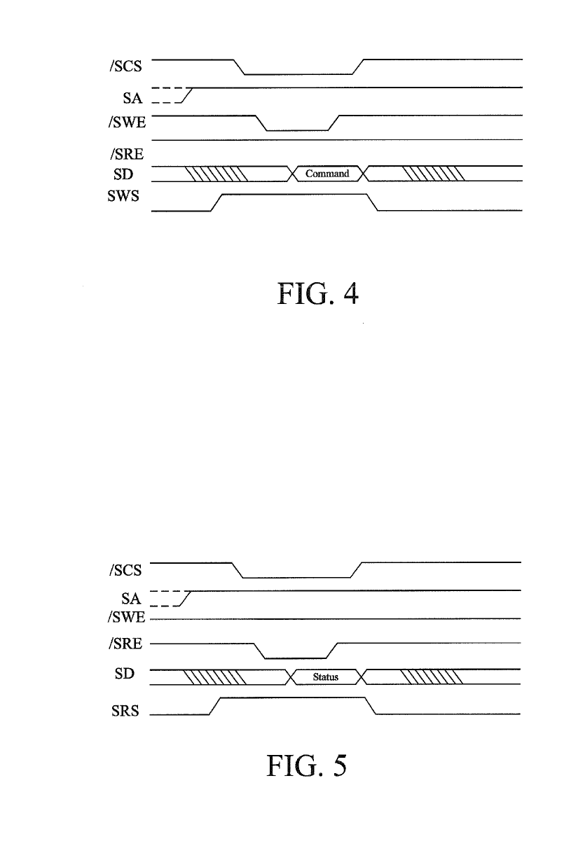

Please refer to FIG. 3 and FIG. 4. FIG. 4 is a schematic timing diagram depicting a command writing procedure of the communicating module 102 according to one embodiment of the present invention. While the multimedia player 118 writes a command to the multimedia adapting apparatus 101, the communicating module 102 activates the address signal (SA) at a high level. Further, the communicating module 102 activates the write status signal (SWS) of the status register 110 at a high level so that the multimedia adapting apparatus 101 is ready for the command writing procedure of the multimedia player 118 via the communicating module 102. While the chip select signal (SCS) is activated as a low level, the command is latched at the rising edge of the write enabled signal (SWE). When the write status signal (SWS) of the status register 110 is activated at a low level, the command is latched at the command register 108 of the multimedia adapting apparatus 101.

Please refer to FIG. 3 and FIG. 5. FIG. 5 is a schematic timing diagram depicting a status reading procedure of the communicating module 102 according to one embodiment of the present invention. While the multimedia player 118 performs a status reading procedure on the multimedia adapting apparatus 101, the communicating module 102 activates the address signal (SA) at a high level. Further, the communicating module 102 activates the read status signal (SRS) of the status register 110 at a high level so that the multimedia adapting apparatus 101 is ready for the status reading procedure of the multimedia player 118 via the communicating module 102. While the chip select signal (SCS) is activated at a low level, the register status is latched at the rising edge of the read enabled signal (SRE). After the status reading procedure is complete, the read status signal (SRS) of the status register 110 is activated at a low level.

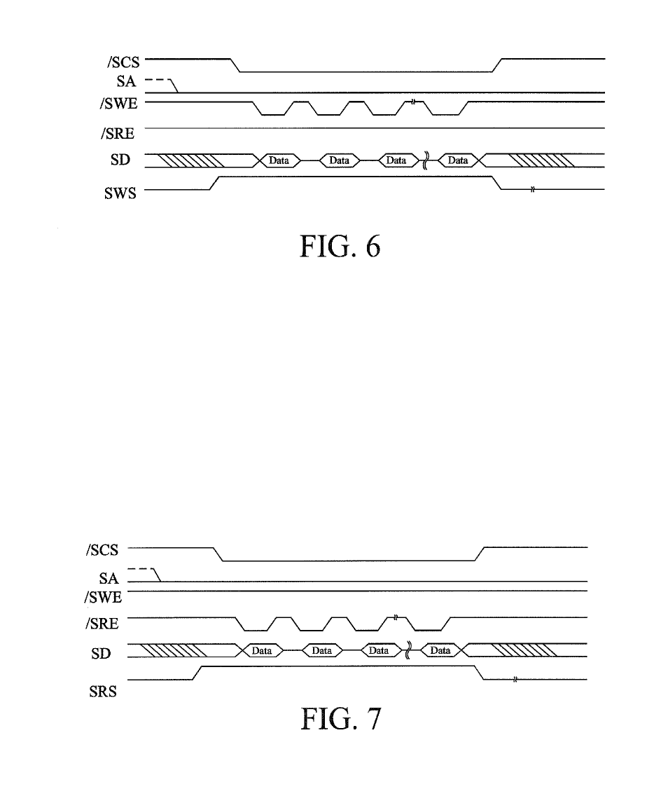

Please refer to FIG. 3 and FIG. 6. FIG. 6 is a schematic timing diagram depicting a data writing procedure of the communicating module 102 according to one embodiment of the present invention. While the multimedia player 118 writes the data, such as audiovisual content, to the multimedia adapting apparatus 101, the communicating module 102 activates the address signal (SA) at a low level. Further, the communicating module 102 activates the write status signal (SWS) of the status register 110 at a high level so that the buffer 104 is ready for the data writing procedure by the data signal (SD). While the chip select signal (SCS) is activated at a low level, the processing device continuously writes the data signal (SD) associated with audiovisual content to the buffer 104 via the communicating module 102. In one embodiment, the data signal (SD) is latched at the rising edge of the write enabled signal (SWE). After the writing operation of the data is complete and the data are latched into the buffer 104, the communicating module 102 activates the write status signal (SWS) of the status register 110 at a low level. When the buffer 104 is ready for the data writing procedure for the processing device, the communicating module 102 activates the write status signal (SWS) of the status register 110 at a high level.

Please refer to FIG. 3 and FIG. 7. FIG. 7 is a schematic timing diagram depicting a data reading procedure of the communicating module 102 according to one embodiment of the present invention. While the multimedia player 118 read the data, such as audiovisual content, from the multimedia adapting apparatus 101, the communicating module 102 activates the address signal (SA) at a low level. Further, the communicating module 102 activates the read status signal (SRS) of the status register 110 at a high level so that the buffer 104 is ready for the data reading procedure by the data signal (SD). While the chip select signal (SCS) is activated at a low level, the processing device continuously read the data signal (SD) associated with audiovisual content via the communicating module 102. In one embodiment, the data signal (SD) is latched at the rising edge of the read enabled signal (SRE). After the reading operation of the data content is complete, the communicating module 102 activates the read status signal (SRS) of the status register 110 at a low level. When the buffer 104 is ready for the data reading procedure for the processing device, the communicating module 102 activates the read status signal (SRS) of the status register 110 at a high level.

According to the above-mentioned descriptions, the present invention provides a multimedia adapting apparatus for allowing a multimedia player to control the audiovisual content of portable multimedia device. Further, the audiovisual content and/or data can be copied or modified between the portable multimedia devices, such as between USB devices and flash card devices, via the secondary controller and the multimedia adapting apparatus. The multimedia adapting apparatus of the present invention improves the convenience, feasibility and cost of the multimedia player by using the communicating module and the configurable unit.

As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structure.

What is claimed is:

1. A multimedia device, comprising:
a player data bus, connected to a data bus to a multimedia player for transmitting audiovisual content;
a player I/O interface, connected to an I/O interface of the multimedia player;
a microprocessor connected to the player data bus and the player I/O interface, for forming bi-directional data transmission connection with the multimedia player through the player data bus and the player I/O interface, wherein the microprocessor controls the play data bus and the player I/O interface to communicate with the multimedia player based on a plurality of control signals;
a memory unit, connected to the microprocessor to provide temporary storage of data and programs to the microprocessor;
a USB controller, connected to the microprocessor, and connected externally to a digital multimedia device having an USB interface, for bi-directional data transmission between the external digital multimedia device and the multimedia player;
a buffer, connected to the microprocessor and the USB controller to provide temporary storage; and
a media hardware engine, connected to the buffer and the microprocessor, and connected externally to a flash memory card for providing bi-directional data transmission between the external flash memory card and the multimedia player.

2. The multimedia device of claim 1, wherein the control signals are selected from one group consisting of a chip select signal (SCS), an address signal (SA), a read enabled signal (SRE), a write enabled signal (SWE), data signal (SD), a write status signal (SWS), a read status signal (SRS) and the combinations thereof.

3. The multimedia device of claim 2, wherein the chip select signal (SCS) represents the multimedia device is active while the multimedia device is selected by the multimedia player.

4. The multimedia device of claim 2, wherein the address signal (SA) determines whether the multimedia device is operated at a command write mode and a status read mode, and at a data receiving/transmitting mode.

5. The multimedia device of claim 2, wherein the read enabled signal (SRE) represents that the multimedia device can be read by the multimedia player while the read enabled signal (SRE) is active.

6. The multimedia device of claim 2, wherein the write enabled signal (SWE) represents that the multimedia device can be written by the multimedia player while the write enabled signal (SWE) is active.

7. The multimedia device of claim 2, wherein the data signal (SD) represents that the audiovisual content, and the statuses are transmitted between the multimedia player and the multimedia device.

8. The multimedia device of claim 2, wherein the write status signal (SWS) indicates that the multimedia player is capable of writing the audiovisual content to the multimedia device while the write status signal (SWS) is active.

9. The multimedia device of claim 2, wherein the read status signal (SRS) indicates that the multimedia player is capable of reading the audiovisual content from the multimedia device while the read status signal (SRS) is active.

10. The multimedia device of claim 2, wherein while the chip select signal (SCS) is activated at a low level, the multimedia player continuously controls the write enable signal (SWE) and writes the data signal (SD).

11. The multimedia device of claim 2, wherein while the chip select signal (SCS) is activated at a low level, the multimedia player continuously controls the read enable signal (SRE) and reads the data signal (SD).

12. A multimedia adapting apparatus for controlling an operation of audiovisual content between a multimedia player and a plurality of portable multimedia devices, the multimedia adapting apparatus comprising:
a buffer, for storing the audiovisual content from the multimedia player;
a primary controller coupled to the communicating module and the buffer, respectively, for handling the operation of audiovisual content between the multimedia player and the portable multimedia devices;
a status register coupled to the primary controller, for storing a plurality of statuses associated with the portable multimedia devices.
a command register coupled to the primary controller, for storing a command set associated the operation of audiovisual content between the multimedia player and the portable multimedia devices according to the statuses of the status register; and
a communicating module coupling the buffer and the primary controller, respectively, to the multimedia player, for communicating with the multimedia player based on a plurality of control signals associated with the command set.

13. The multimedia adapting apparatus of claim 12, further comprising a secondary controller coupled to the status which is compatible with USB on-the-go (OTG) standard for either copying or modifying the audiovisual content between the portable multimedia devices.

14. The multimedia adapting apparatus of claim 12, wherein the command set is selected from one group consisting of a reading command, a writing command, formatting command and the combinations thereof.

15. The multimedia adapting apparatus of claim 12, wherein the primary controller further monitors a plurality of status change events of the portable multimedia devices.

16. The multimedia adapting apparatus of claim 12, wherein the status register records the status change events.

17. The multimedia adapting apparatus of claim 12, further comprising a media hardware engine coupled to the buffer and the status register, respectively, for serving as a plurality of interface of flash memory cards.

18. The multimedia adapting apparatus of claim 12, wherein the control signals are selected from one group consisting of a chip select signal (SCS), an address signal (SA), a read enabled signal (SRE), a write enabled signal (SWE), data signal (SD), a write status signal (SWS), a read status signal (SRS) and the combinations thereof.

19. The multimedia adapting apparatus of claim 18, wherein the chip select signal (SCS) represents the multimedia adapting apparatus is active while the multimedia adapting apparatus is selected by the multimedia player.

20. The multimedia adapting apparatus of claim 18, wherein the address signal (SA) determines whether the multimedia adapting apparatus is operated at a command write mode and a status read mode, and at a data receiving/transmitting mode.

21. The multimedia adapting apparatus of claim 18, wherein the read enabled signal (SRE) represents that the multimedia adapting apparatus can be read by the multimedia player while the read enabled signal (SRE) is active.

22. The multimedia adapting apparatus of claim 18, wherein the write enabled signal (SWE) represents that the multimedia adapting apparatus can be written by the multimedia player while the write enabled signal (SWE) is active.

23. The multimedia adapting apparatus of claim 18, wherein the data signal (SD) represents that the audiovisual content, the statuses, and the command set are transmitted between the multimedia player and the multimedia adapting apparatus.

24. The multimedia adapting apparatus of claim 18, wherein the write status signal (SWS) indicates that the multimedia player is capable of writing either the command set or the audiovisual content to the multimedia adapting apparatus while the write status signal (SWS) is active.

25. The multimedia adapting apparatus of claim 18, wherein the read status signal (SRS) indicates that the multimedia player is capable of reading either the command set or the audiovisual content from the multimedia adapting apparatus while the read status signal (SRS) is active.

26. The multimedia adapting apparatus of claim 18, wherein while the chip select signal (SCS) is activated at a low level, a processing device of the multimedia player continuously controls the write enable signal (SWE) and writes the data signal (SD) associated with the audiovisual content to the buffer via the communicating module.

27. The multimedia adapting apparatus of claim 18, wherein while the chip select signal (SCS) is activated at a low level, the processing device of the multimedia player continuously controls the read enable signal (SRE) and reads the data signal (SD) associated with the audiovisual content via the communicating module.
